(19) United States
(12) Patent Application Publication
(10) Pub. No.: US 2004/0050481 A1
(43) Pub. Date: Mar. 18, 2004

(54) Method and apparatus for forming belt loops

(76) Inventors: Erich Coiner, Poway, CA (US); David Burney, Ramona, CA (US); Alan Jacques, San Diego, CA (US)

Correspondence Address: Frederic M. Douglas, Aetas Technology, Inc., Suite 200, 120 Theory Drive, Irvine, CA, 92612-3045, US

(21) Appl. No.: 10/244,977

(22) Filed: Sep. 17, 2002

(51) Int. Cl. B29C 53/00; B32B 31/00; B29C 31/00; B29C 65/00; B65C 1/00; B31F 1/00; G03D 15/04

(52) U.S. Cl. 156/217; 156/228; 156/275.1; 156/304.1; 156/443; 156/494; 156/507; 156/539

(57) ABSTRACT

The invention includes a belt forming apparatus. The belt forming apparatus includes a station. The station includes a first invertible gripping member, a second invertible gripping member, and a welder having a nib placed relative to the first invertible gripping member and the second invertible gripping member. Moreover, the first invertible gripping member and the second invertible gripping member are adapted to wrap a web segment to form a lap joint that is disposed adjacent to the nib of the welder

### SPECIFICATION

1. Field of the Invention

The present invention relates generally to an image forming apparatus including an electrophotographic copier and a printer. In particular, the invention relates to forming an organic photoconductor belt.

2. Background Art

The belt of an imaging system is formed from a web segment of at least two layers connected in a continuous band. A first layer may be of a flexible, transparent material that permits the passage of light and provides a stable platform for a second layer. The second layer is made of a photoconductive material that is placed on the first layer. The photoconductive material is adapted to attract, hold, and release toner particles.

To form the layers of the belt into a continuous band, a measure of the layers from a web supply roll is cut into a web (or web segment). The opposing ends of the web conventionally are wrapped to meet as a web lap joint to form a belt loop at a first location. The belt loop then is moved to a second location. At the second location, the belt loop is welded to join the web to form a looped, unitary configuration having a seam at the web lap joint.

The movement of the web from a first location to a second location is inefficient. The time it takes to move the web slows down production. Moreover, additional machinery required to move the web increases start up costs as well as maintenance and repair costs. Further, the additional handling of a web increases the likelihood of damaging the photosensitive layer of the web or skewing the web lap joint.

### SUMMARY OF THE DISCLOSURE

A number of technical advances are achieved in the art, by implementing of an imaging system including a photoconductive belt that is wrapped and welded in a single location. The invention includes a belt forming apparatus. The belt forming apparatus includes a station, where belt wrapping and welding occur at this same station. Unlike previous arrangements for forming belts, the present invention involves welding the belt seam at the same station as where the belt is formed. Previous methods involve moving the wrapped belt material to a separate station for welding. This greatly increases the likelihood of a belt overlap becoming misaligned while shifting the belt to a separate welding station. The present invention comprises a station that includes at least one member for wrapping a belt. The wrapping member may move in a controlled translational manner. The wrapping member may also move in a controlled rotational manner. A slide (e.g. a groove or a rack-and-pinion structure) can be used to help control the wrapping movement. One embodiment includes a first invertible gripping member (e.g. a chuck), a second invertible gripping member, and a welder having a nib placed relative to the first invertible gripping member and the second invertible gripping member. The first invertible gripping member and the second invertible gripping member are adapted to wrap a web segment to form a lap joint that is disposed adjacent to the nib of the welder. Another embodiment can include simultaneous rotation and translation of wrapping members.

Other systems, methods, features and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is an isometric view of a belt 100;

FIG. 2 illustrates a belt forming apparatus 200;

FIG. 3 illustrates a receiving process; and

FIG. 4 illustrates a wrapping and welding process.

FIG. 5 is a representative illustration of the surface of shoe 220.

FIG. 6 illustrates a wrapping and welding process during welding.

FIG. 7 illustrates a wrapping and welding process after complete welding.

### BEST MODES OF PRACTICING THE INVENTION

While the present invention may be embodied in many different forms, there is shown in the drawings and discussed herein a few specific embodiments with the understanding that the present disclosure is to be considered only as an exemplification of the principles of the invention and is not intended to limit the invention to the embodiments illustrated. By way of summary, the invention includes a method to wrap and weld a photoconductive belt without moving the location of the belt.

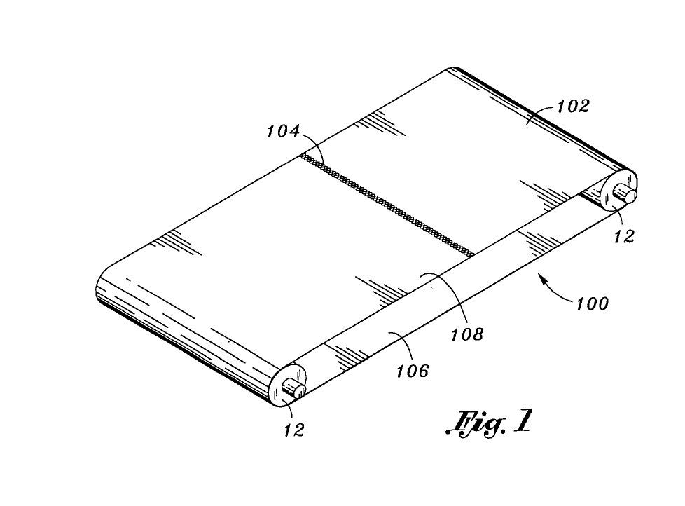

FIG. 1 is an isometric view of a belt 100. Included with the belt 100 may be a web segment 102 and a seam 104. The web segment 102 may be a divided piece of thermoplastic material from a web supply roll (not shown). The seam 104 may be formed of two ends of the web segment 102 brought together as a web lap joint and welded. The seam 104 defines a location known as the home position. The belt 100 may be a continuous band having an interior surface 106 and an exterior surface 108. Moreover, the belt 100 may be an organic photoconductive (OPC) belt.

In one embodiment, the belt 100 may be made of a flexible, transparent material having a photoconductive layer. The photoconductive layer may include an organic semiconductor material such as selenium, germanium or silicon.

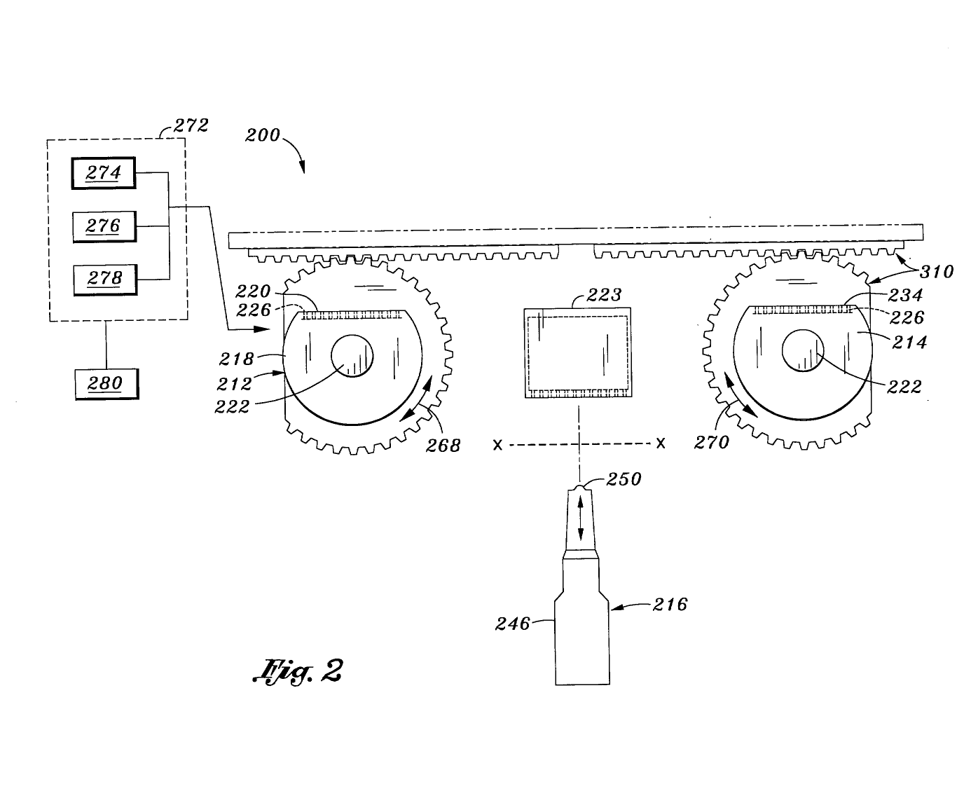

FIG. 2 illustrates a belt forming station 200. The belt forming apparatus may be used to manufacture the belt 100 of FIG. 1. Included with the belt forming apparatus may be a cutting area (not shown). In one embodiment, the cutting area is disposed in the same location as a location of the station 200.

The station 200 may be thought of as a wrapping and welding station. The cutting area may receive OPC material from a web supply roll and slice the material into individual web segments. Station 200 may include a first vacuum invertible gripping member 212, a second invertible gripping member 214, and a welder 216. The description of the first vacuum invertible gripping member 212 applies equivalently to the second invertible gripping member 214. The first invertible gripping member 212 may include a substantially round portion 218, a planar side (“shoe”) 220, and an axis 222. The vacuum invertible gripping member 212 performs at least two movements, rotation and translation. Rotation entails the vacuum invertible gripping member 212 rotating upon axis 222. Translation entails the vacuum invertible gripping member 212 moving in a plane substantially orthogonal with the axis 222. Rotation and translation can occur simultaneously.

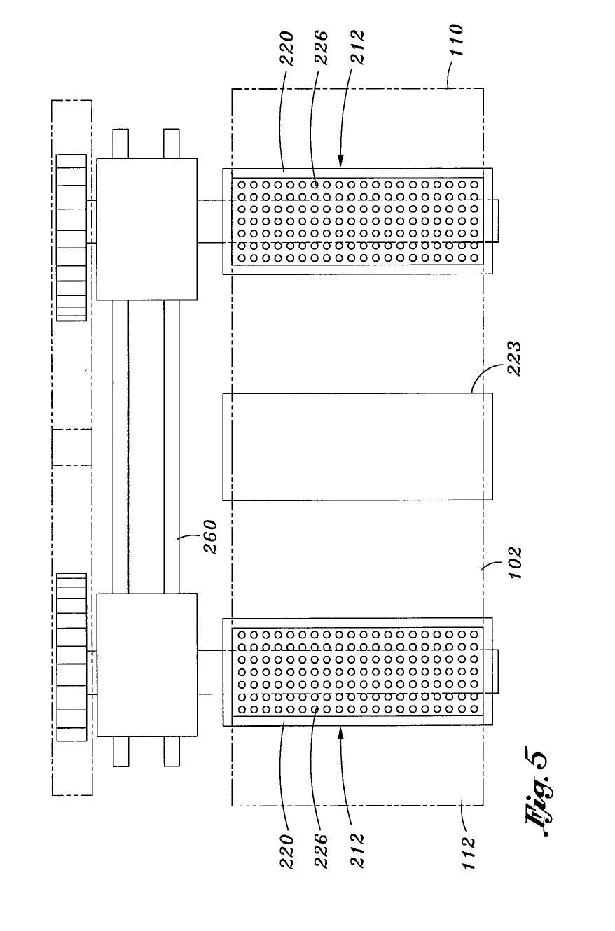

The shoe 220 may function to grab a substrate, such as web segment 102, through a vacuum. The shoe 220 may include grooves, holes, or be made of porous, sintered particles of any suitable shape to pass a vacuum to a surface 226 of the shoe 220, as shown in FIG. 5.

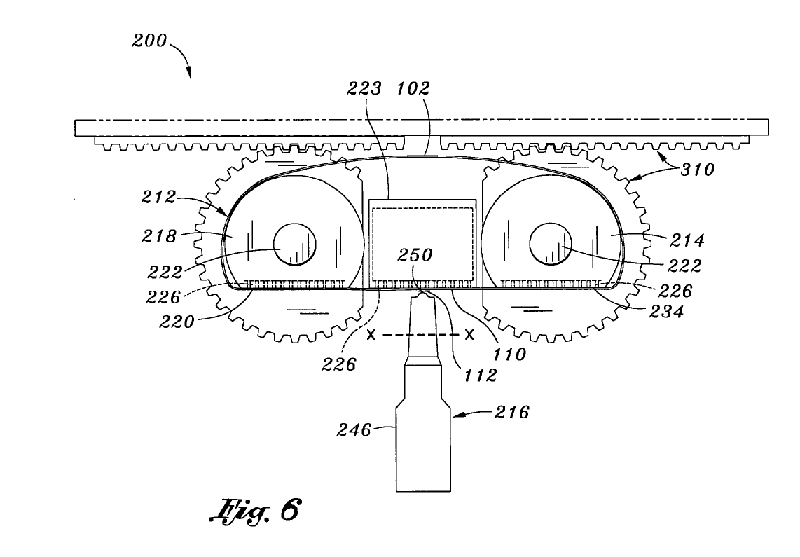

Referring to FIG. 2 and FIG. 6, the station 200 may include the welder 216. The welder 216 may be an ultrasonic horn that is adapted to produce a high vibration whose frequency is sufficient to raise the temperature of the material of the web segment 102. Referring to FIG. 2 and FIG. 6, an ultrasonic belt welding station 200 comprising an ultrasonic horn assembly 246 is illustrated. The ultrasonic horn extends or retracts in a vertical direction. The web lap joint (not shown) formed by the overlapping segment ends of thermoplastic web segment 102 is supported by the lower surface of anvil 223 and held in place above the path of ultrasonic horn assembly 246 by suction from grooves or holes 226 (see FIG. 5 and FIG. 6). The ultrasonic horn is supported by the upper end of a vertically reciprocateable shaft (not shown). The welder may be operated using a linear servomotor (not shown).

The welding surface (nib) 250 of the ultrasonic horn in ultrasonic horn 246 may be of any suitable shape such as the flat or curved cross-sectional shapes illustrated, for example, in U.S. Pat. No. 3,459,610 and U.S. Pat. No. 4,532,166. The high vibration frequency of the ultrasonic horn along its vertical axis causes the temperature of at least the contiguous overlapping surfaces of thermoplastic web segment 102 to increase until at least the thermoplastic material in web segment 102 flows. Welding of the contiguous overlapping surfaces of thermoplastic web segment 102 will also occur if web segment 102 also comprises thermoplastic material that flows because of the applied energy of ultrasonic oscillations. The thermoplastic web segment 102 may be coated with thermoplastic coatings. The thermoplastic material that is induced to melt and weld the seam may be provided solely by a coating on the web, from both a coating and a web substrate, or solely from the web itself. The web may be of any suitable thickness that will allow adequate heating of the contiguous overlapping surfaces of the web edges to permit sufficient heat energy to be applied at the contiguous overlapping surfaces to cause the thermoplastic material to melt and weld the overlapping edges of web segment 102 at seam 104.

Any suitable heating technique may be used to provide the heat necessary at the contiguous overlapping surfaces to melt the thermoplastic material and cause it to weld web segment 102 at the lap joint 104. Typical heating techniques include ultrasonic welding, radio frequency heating and the like. Ultrasonic welding is preferred because it causes generation of heat at the contiguous overlapping surfaces of the web edges at the lap joint to maximize melting of the thermoplastic material. If desired, the born may comprise highly thermoconductive material such as aluminum to ensure achievement of higher temperatures at the interface between the overlapping edges of web segment 102 and to minimize thermal distortion of the exposed surfaces of the web segment 102. When ultrasonic welding is used, it is believed that the rapid impaction of one edge of web segment 112 with the other edge of web segment 110 at the contiguous overlapping web surfaces between the anvil 223 and nib 250 causes generation of heat. A horn vibration frequency of about 16,000 kHz or higher may be used to cause the thermoplastic material to soften. A typical horn suitable for joining thin thermoplastic webs uses a sonic generator of about 400-800 watt capacity, an operational frequency of about 20 kHz, and a flat input horn welding surface about 12 millimeters long and about 0.04 to 0.1 centimeter wide. Typical motion amplitude for this horn is about 76 micrometers. The horn assembly 246 moves into and out of the plane X-X of FIG. 2.

The rack and pinion assembly 310 may permit the first invertible gripping member 212 to rotate in the direction of the arrow 268. Moreover, the rack and pinion assembly 310 may permit the second invertible gripping member 214 to rotate in the direction of the arrow 270. The first invertible gripping member 212 may be disposed with a gear coaxial with the gripping member 212. Moreover, the second invertible gripping member 214 may be disposed with a gear coaxial with the gripping member 214. The gears rotate in communication with respective pinions to accurately control gripping member motion for translation and rotation. In one embodiment, a motor (not shown) is provided that is adapted to convert electrical power into rotational motion and translational motion.

The belt forming station 200 may also include auxiliary services 272. The auxiliary services 272 may include gas 274, fluid 276, and electricity 278. The gas 274 may include a gas such as air that is pressurized under a vacuum. The fluid 276 may include hydraulic fluid to rotate the apparatus parts. The electricity 278 may be coupled to motors (not shown ) that work to drive the moveable components of the belt forming station 200. In another embodiment, a pneumatic cylinder (not shown) provides energy for rotational and translational motion. The auxiliary services 272 may be coupled to a computer 280. The computer 280 may be any machine that may be programmed to manipulate data to perform complex and repetitive procedures through storage and retrieval of large amounts of data.

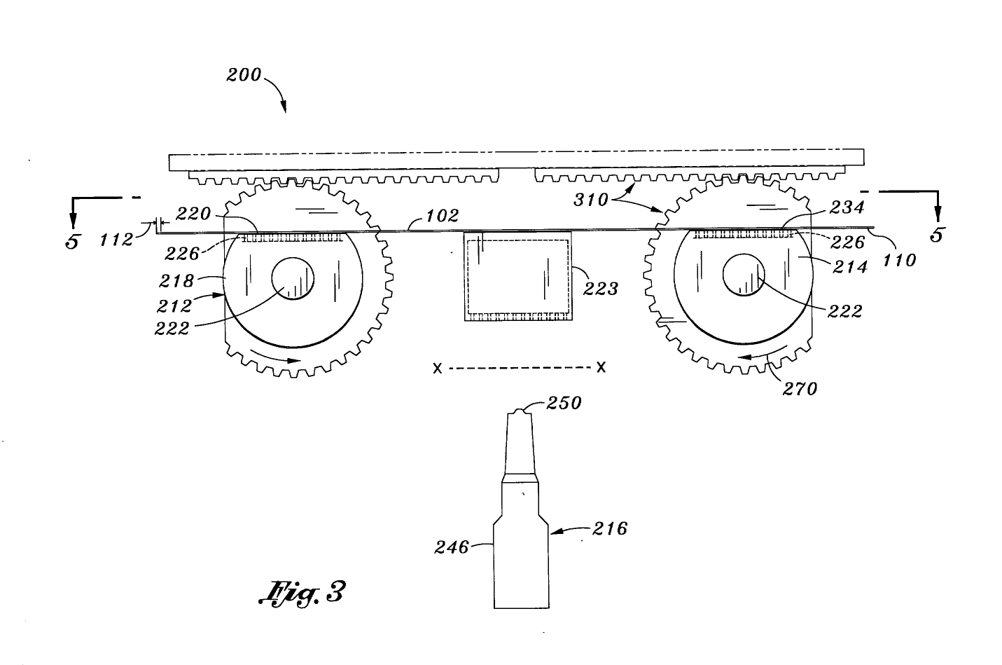

FIG. 3 illustrates a receiving process. As seen in FIG. 3, the station 200 is shown after the receipt of the web segment 102 from the cutting area (not shown). On receiving the web segment 102, a vacuum may be applied to both shoe 220 and shoe 234 to draw the web segment 102 against their respective surfaces. The web segment 102 may be positioned so that web end 110 extends beyond an end of the shoe 234 and so that end 112 extends beyond an end of the shoe 220 even farther.

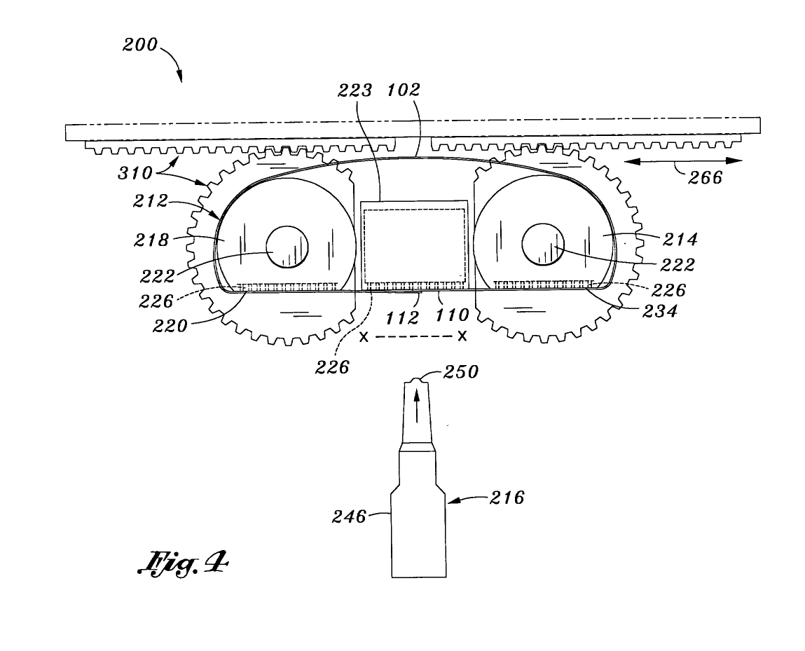

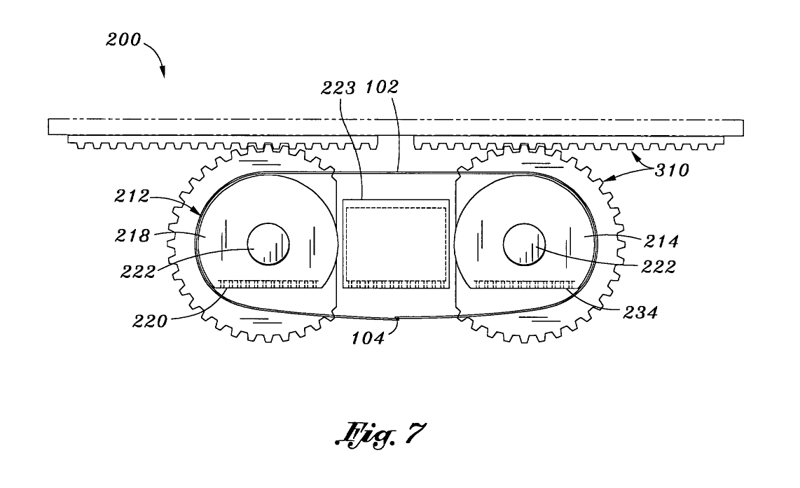

FIG. 4 illustrates an intermediate step in a wrapping and welding process. To wrap the web segment 102, both the first invertible gripping member 212 and the second invertible gripping member 214 may be rotated about their respective axles 222. At the same time, the first invertible gripping member 212 and the second invertible gripping member 214 may be moved towards, or away from, one another along the rack and pinion assembly 310 in the direction of the arrow 266. In this arrangement, end 112 of the web segment 102 may be disposed over end 110, as shown in FIG. 4. The nib 250 of the welder 216 then may be positioned to move against end 112 and the end 110 to weld the area of overlap. As shown in FIG. 6, with the nib 250 in position, the nib 250 may be activated to vibrate and moved back and forth. The ends, 110 and 112, of the thermoplastic material of the web segment 102 may be urged to fuse and adhere together to form the seam 104 (FIG. 7).

The foregoing description and drawings merely explain and illustrate the invention. Those persons of skill in the art who have the present disclosure before them will be able to make modifications and variations therein without departing from the scope of the present invention. For example, the ends of the web segment 102 may be reversed so that end 110 may be disposed over end 112. In addition, either end may extend beyond an end of either shoe 220 or 234.

What is claimed is:

1. A belt forming apparatus, comprising:
a station having at least one gripping member,
and a welder having a nib disposed relative to the at least one gripping member,
wherein the at least one gripping member includes a means for wrapping a web segment to form a lap joint that is disposed adjacent to the nib of the welder.

2. The apparatus of claim 1, wherein the means for wrapping includes a rack and pinion assembly coupled with the at least one gripping member and a means for moving.

3. The apparatus of claim 2, wherein the means for moving comprises a motor that is adapted to convert electrical power into rotational motion.

4. The apparatus of claim 2, wherein the means for moving comprises a device that is adapted to convert pneumatic power into rotational motion.

5. The apparatus of claim 2, wherein the means for moving comprises a motor that is adapted to convert electrical power into translational motion.

6. The apparatus of claim 2, wherein the means for moving comprises a device that is adapted to convert pneumatic power into translational motion.

7. The apparatus of claim 2, wherein the means for moving comprises a motor that is adapted to convert electrical power into rotational and translational motion.

8. The apparatus of claim 2, wherein the means for moving comprises a device that is adapted to convert pneumatic power into rotational and translational motion.

9. A belt forming apparatus, comprising:
a station having a first invertible gripping member, a second invertible gripping member,
and a welder having a nib disposed relative to the first invertible gripping member and the second invertible gripping member,
wherein the first invertible gripping member and the second invertible gripping member include a means for wrapping a web segment to form a lap joint that is disposed adjacent to the nib of the welder.

10. The apparatus of claim 9, wherein the means for wrapping includes a first rack and pinion assembly coupled with the first invertible gripping member and a means for moving, and a second rack and pinion assembly coupled with the second invertible gripping member and a means for moving.

11. The apparatus of claim 10, wherein the means for moving comprises a motor that is adapted to convert electrical power into rotational motion.

12. The apparatus of claim 10, wherein the means for moving comprises a device that is adapted to convert pneumatic power into rotational motion.

13. The apparatus of claim 10, wherein the means for moving comprises a motor that is adapted to convert electrical power into translational motion.

14. The apparatus of claim 10, wherein the means for moving comprises a device that is adapted to convert pneumatic power into translational motion.

15. The apparatus of claim 10, wherein the means for moving comprises a motor that is adapted to convert electrical power into rotational and translational motion.

16. The apparatus of claim 10, wherein the means for moving comprises a device that is adapted to convert pneumatic power into rotational and translational motion.

17. A wrapping and welding station, comprising:
a first invertible gripping member,
a second invertible gripping member; and
a welder having a nib disposed relative to the first invertible gripping member and the second invertible gripping member,
wherein the first invertible gripping member and the second invertible gripping member include a means for wrapping a web segment to form a lap joint that is disposed adjacent to the nib of the welder.

18. The station of claim 17, wherein the means for wrapping includes a first rack and pinion assembly coupled with the first invertible gripping member and a means for moving, and a second rack and pinion assembly coupled with the second invertible gripping member and a means for moving.

19. The apparatus of claim 17, wherein the means for moving comprises a motor that is adapted to convert electrical power into rotational motion.

20. The apparatus of claim 17, wherein the means for moving comprises a device that is adapted to convert pneumatic power into rotational motion.

21. The apparatus of claim 17, wherein the means for moving comprises a motor that is adapted to convert electrical power into translational motion.

22. The apparatus of claim 17, wherein the means for moving comprises a device that is adapted to convert pneumatic power into translational motion.

23. The apparatus of claim 17, wherein the means for moving comprises a motor that is adapted to convert electrical power into rotational and translational motion.

24. The apparatus of claim 17, wherein the means for moving comprises a device that is adapted to convert pneumatic power into rotational and translational motion.

25. A method to wrap and weld a web segment, comprising:
presenting a web segment to a wrapping and welding station;
wrapping the web segment, at the wrapping and welding station, to form a lap joint that is disposed adjacent to the nib of a welder; and
welding the wrapped web segment, at the wrapping and welding station, at the lap joint.

26. A method to wrap and weld a web segment, comprising:
presenting the web segment to a wrapping and welding station comprising a first invertible gripping member, a second invertible gripping member, and a welder having a nib disposed relative to the first invertible gripping member and the second invertible gripping member; and
wrapping the web segment to form a lap joint that is disposed adjacent to the nib of the welder by employing the first invertible gripping member and the second invertible gripping member.

27. The method of claim 26, wherein wrapping includes simultaneously rotating and moving the first invertible gripping member and the second invertible gripping member towards one another using a first rack and pinion assembly coupled with the first invertible gripping member and a motor and a second rack and pinion assembly coupled with the second invertible gripping member and a motor.

28. The method of claim 26, wherein wrapping includes simultaneously rotating and moving the first invertible gripping member and the second invertible gripping member towards one another using a first rack and pinion assembly coupled with the first invertible gripping member and a pneumatic device and a second rack and pinion assembly coupled with the second invertible gripping member and a pneumatic device.
